(19) United States
(12) Patent Application Publication
(10) Pub. No.: US 2005/0079478 A1
(43) Pub. Date: Apr. 14, 2005

(54) Learning system

(76) Inventors: Francis McKeagney, County Dublin (IE); Robert Brady, County Kildare (IE); Claudio Perrone, County Dublin (IE); David Meaney, Dublin (IE); Seamus Brady, Dublin (IE)

Correspondence Address: JACOBSON HOLMAN PLLC, 400 SEVENTH STREET N.W., SUITE 600, WASHINGTON, DC, 20004, US

(21) Appl. No.: 10/958,388

(22) Filed: Oct. 6, 2004

Related U.S. Application Data
(60) Provisional application No. 60/509,265, filed on Oct. 8, 2003.

(51) Int. Cl. G09B 19/00

(52) U.S. Cl. 434/350; 434/362

(57) ABSTRACT

A learning system (1) comprises control functions (2), and student interfacing functions (3). The system (1), at a high level, also comprises a set (4) of stored third party software development tools which can be launched by an opening function within the learning controller (2). The system (1) also comprises a set (5) of stored challenges called practice sets, each for presenting a challenge to a student involving use of one or more software development tools. A task engine (6) controls the presentation of challenges to students. A support engine (7) manages retrieval and outputting of support content and instruction tutors for guidance of a student. A judging engine (8) automatically analyses software developed by a student to generate a result. The result provides a competency profile, something which is very valuable to the student as it clearly indicates deficiencies in ability or knowledge.

### FIELD OF THE INVENTION

The invention relates to systems for computer-based learning or training for students such as software development students.

### PRIOR ART DISCUSSION

Heretofore, such systems have been developed with a view to progressing through a series of items of educational course content.

While such an approach is effective for some learning subjects, it has been found to be lacking in the field of software development learning. This is reflected in statistics demonstrating high failure rates for software projects. Even where a software project is successful, it often involves engineers learning “on the job” at the expense of the employer.

The invention is directed towards providing a learning system to overcome these problems and to bridge the gap between the conceptual knowledge students acquire through conventional instructional training and the practical competencies they develop.

### SUMMARY OF THE INVENTION

According to the invention, there is provided a computer-based learning system comprising a learning controller for presenting learning content to a student, and
a launch function for launching a computer application providing a live programming environment,
a task function for presenting a task to a student involving use of an application, and
a judging engine for testing student success when performing the task in the live programming environment.

In one embodiment, the application is a software development tool, and the judging engine tests software code developed by the student.

In another embodiment, the task function generates a task comprising student instructions for writing software code, and starting software code to be edited or expanded by the student.

In a further embodiment, the task function resets student code upon receipt of a student instruction to initiate a fresh task.

In one embodiment, the judging engine maintains a count of the number of attempts at completion of a task by a student in a session.

In another embodiment, the judging engine automatically generates a detailed explanation of where student mistakes were made.

In a further embodiment, the system comprises a support engine for retrieving support content in response to a student request.

In one embodiment, said support engine accesses remote servers to retrieve support content.

In another embodiment, the judging engine comprises configuration files of potential student feedback messages, and automatically selects messages in response to testing.

In a further embodiment, the configuration file is in markup language format, and selected messages are rendered to HTML for display at a student interface.

In one embodiment, the judging engine comprises black box testing functions for executing student code and determining success or failure according to overall code performance.

In another embodiment, the judging engine comprises functions for parsing student code to analyse it.

In a further embodiment, comments are automatically stripped from the code.

In one embodiment, the code is parsed to detect key words.

In another embodiment, the student code is automatically broken down into its constituent parts, including classes, methods, and properties.

In a further embodiment, the judging engine individually tests constituent parts.

In one embodiment, the judging engine includes interface files which provide student programming language independence when testing the student code constituent parts.

In another embodiment, the judging engine comprises reflection functions for examining student structural elements including assemblies, classes, methods, properties, fields, and attributes.

In a further embodiment, the judging engine performs reflection testing of methods for late binding, in which the method is defined as a string at runtime.

In one embodiment, the judging engine activates monitoring code to execute alongside student code and monitor performance of the student code.

In another embodiment, the monitoring code captures exceptions generated by the student code.

In a further embodiment, the monitoring code generates a mark-up language representation of the exceptions, and the judging engine interprets the mark-up language representation.

In one embodiment, the monitoring code is automatically inserted by the judging engine into compiled student code so that it is non-invasive and transparent to the student.

In another embodiment, the judging engine decompiles original binary-level student code to an intermediate-level language, inserts the monitoring code into the intermediate-level language, and re-compiles to provide fresh student binary-level code.

In a further embodiment, the monitoring code comprises a testable page which calls monitoring functions.

In one embodiment, the testable page is inserted in the intermediate language by changing references to a prior page to the testable page, and in which the testable page refers to the prior page so that operation of the student code is unaffected.

In another embodiment, the monitoring code inserts the mark-up language representation of the exceptions into a page downloaded from a server to a client, thereby enabling the client side to view operations of the server side which would otherwise be hidden.

In a further embodiment, the judging engine comprises a tester object for activating a test of server-side student code by, from the client side, requesting a page from the server side.

In another aspect, the invention provides a method of operation of a computer-based learning system comprising the steps of;
generating a live programming environment with launch of a software development tool;
presenting instructions of a programming task to a student, the task to be completed using the development tool;
providing access to automated support services for guidance of a student undertaking the programming task;
automatically testing program code developed by the student; and
presenting test results to the student with an analysis of any mistakes made.

In one embodiment, the student code is automatically tested with white box analysis of the student code by monitoring code, the monitoring code capturing exceptions generated by the student code while executing.

In another embodiment, the exceptions are converted to a serialisation information stream in a mark-up language.

In a further embodiment, the information stream is incorporated with HTML transmitted by a server to a client.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a block diagram of the high-level functional components of a learning system of the invention;

FIGS. 2 to 7 are sample screen shots illustrating operation of the system;

FIG. 8 is a message sequence diagram for operation of the system; and

FIG. 9 is a flow diagram illustrating operation of the system.

### DESCRIPTION OF THE EMBODIMENTS

System Components

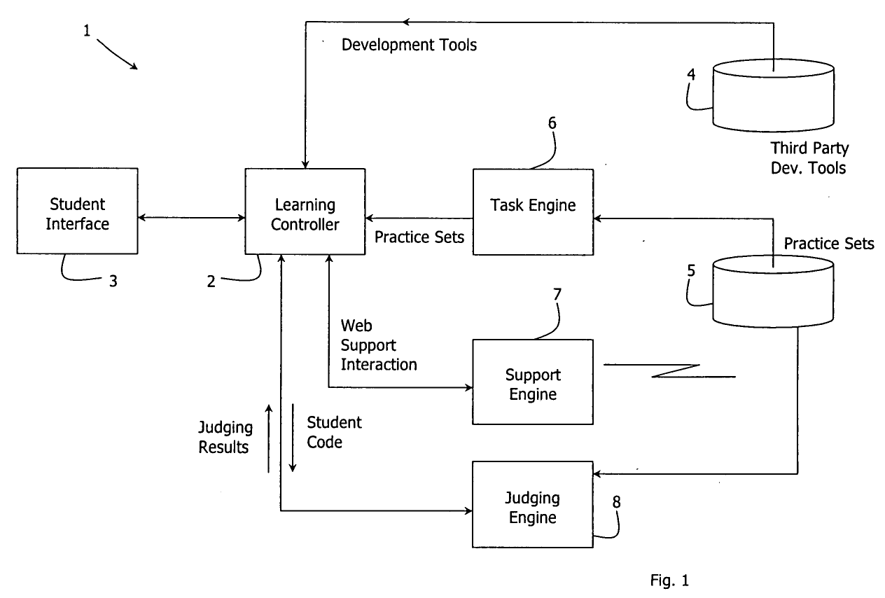

Referring to FIG. 1 a learning system I comprises a block 2 representing control functions, and a block 3 representing student interfacing functions. The system 1, at a high level, also comprises a set 4 of stored third party software development tools such as Microsoft® Visual Studio®.NET which can be launched by an opening function within the learning controller 2. The system I also comprises a set 5 of stored challenges called practice sets, each for presenting a challenge to a student involving use of one or more software development tools. A task engine 6 controls the presentation of challenges to students. A support engine 7 manages retrieval and outputting of support content and instruction tutors for guidance of a student. Finally, a judging engine 8 automatically analyses software developed by a student to generate a result. The result provides a competency profile, something which is very valuable to the student as it clearly indicates deficiencies in ability or knowledge.

The system 1 allows students to take part in situated learning at their place of work, with use of the actual software development tools which are used in real life. Thus, the system 1 avoids the prior approach of generating a virtual environment, in favour of a live programming environment.

Overall System Operation

The task engine 6 retrieves practice sets, which provide the student with software development challenges in real time in the real environment. The practice sets consist of:
Drills, which are a collection of practice challenges called “Tasks” that address common coding techniques. The combination of tasks in a drill provides the student with a rounded experience of techniques relevant to a particular subject area.
Applications are a collection of practice challenges called “Stages”, which build on experience gained in drills and present a higher-level challenge to the student that moves beyond coding techniques to address significant software architecture problems.

The mix of drills and applications in a practice set varies according to difficulty—basic practice sets place an emphasis on drills, while more advanced practice sets focus on complex application development techniques.

Each practice set includes student instructions and also starting software code to be expanded upon to meet the challenge.

The student writes software code in an attempt to meet the challenge generated by the task engine 6. The judging engine 8 uses “black box”, “white box”, and “reflection” techniques to analyse the code developed by the student.

The student is not “alone” while attempting to meet the challenge, as the support engine 6 can be used at any stage to generate or retrieve useful support information to assist the student. The support engine 6 also provides access to a “personal tutor” who supports and guides the student throughout the duration of a practice set.

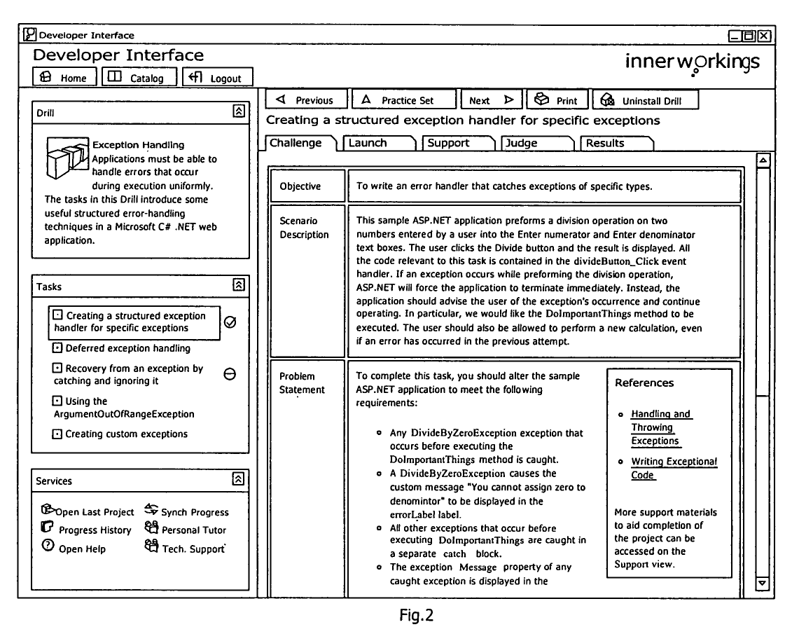

Referring to FIG. 2 a screen displays an overview of a task which is to be presented. This screen gives detail retrieved from the particular task in the practice set 5, including an Objective, a Scenario Description, a Problem Statement, and Constraints. This information provides the student with all the information needed to complete the task or application challenge.

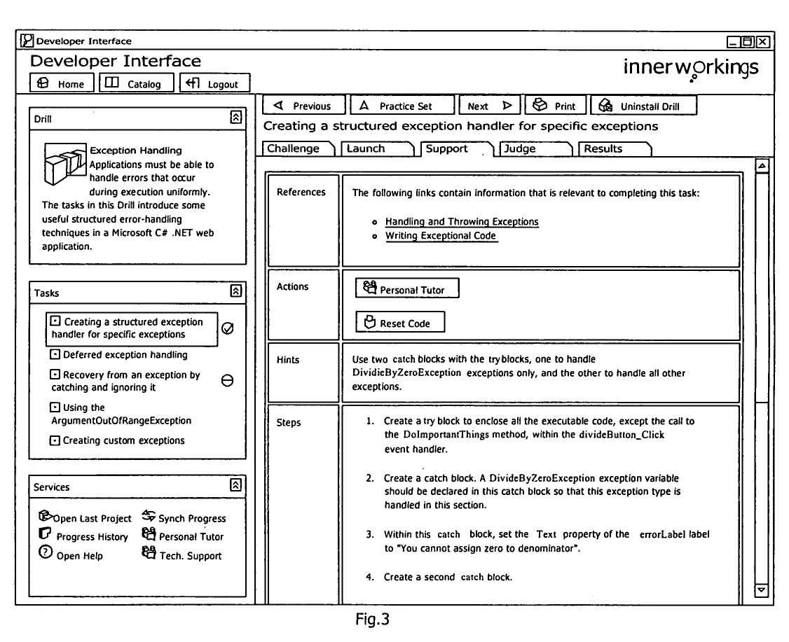

The screen of FIG. 3 is a sample of the support provided by the support engine 7 which supplies HTML links to appropriate reference material websites. This screen includes a button for activating the task engine 6 to reset the code, and buttons for a tutor program to give further explanations concerning the task in the form of an asynchronous on-line discussion. It also includes a Hint field, where appropriate, that highlights the key issues of the challenge.

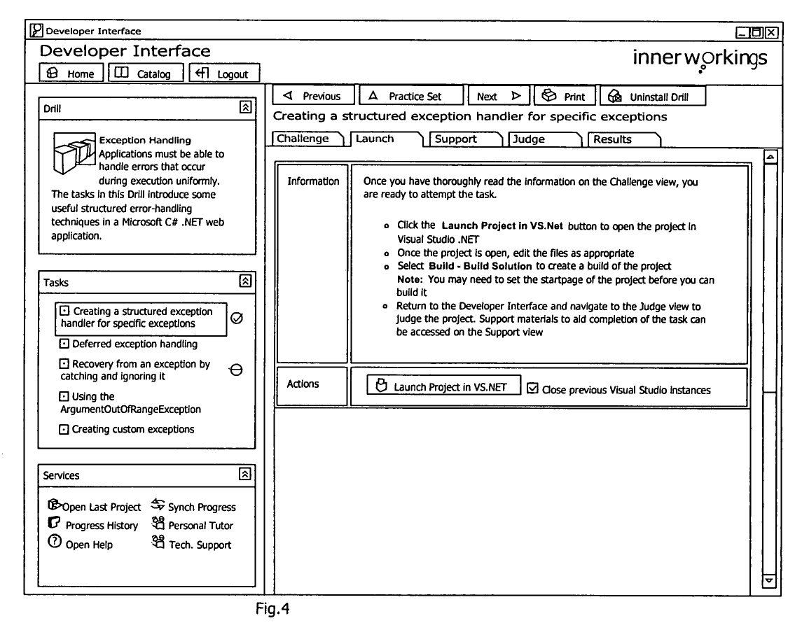

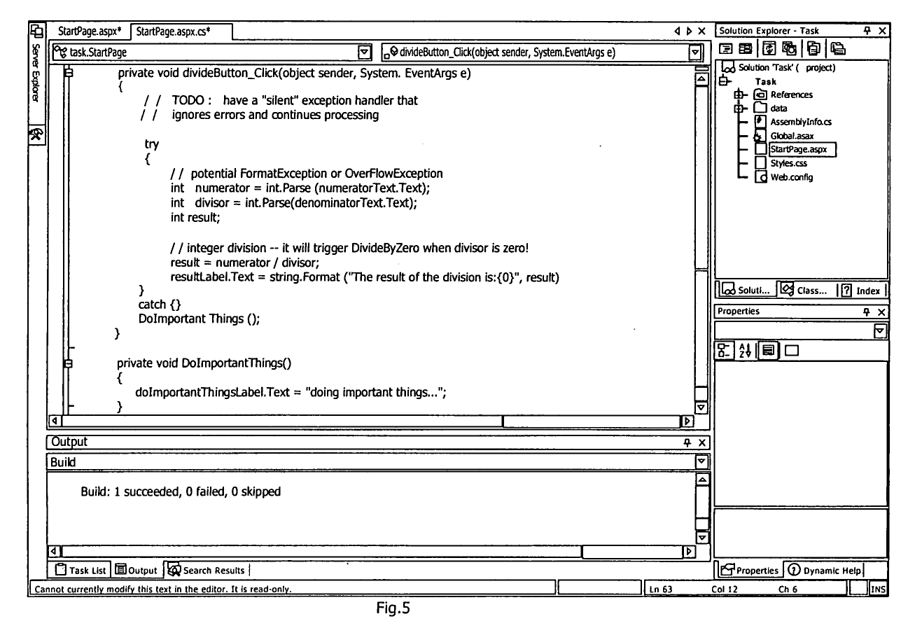

Upon pressing a Launch button in the Launch tab of the interface, the student instructs the controller 2 to launch a particular development application. This generates a screen such as shown in FIG. 4. FIG. 5 displays starting code developed in this real environment. To perform the task, the student edits the starting code as appropriate, both directly and by use of the features provided by the development application. The steps are step-by-step instructions for completing the task. They are not initially visible, as they would excessively simplify the task. Instead, the user must press a button to reveal them, in the knowledge that this action will become part of their progress record, and might reflect less well on them in the eyes of their manager.

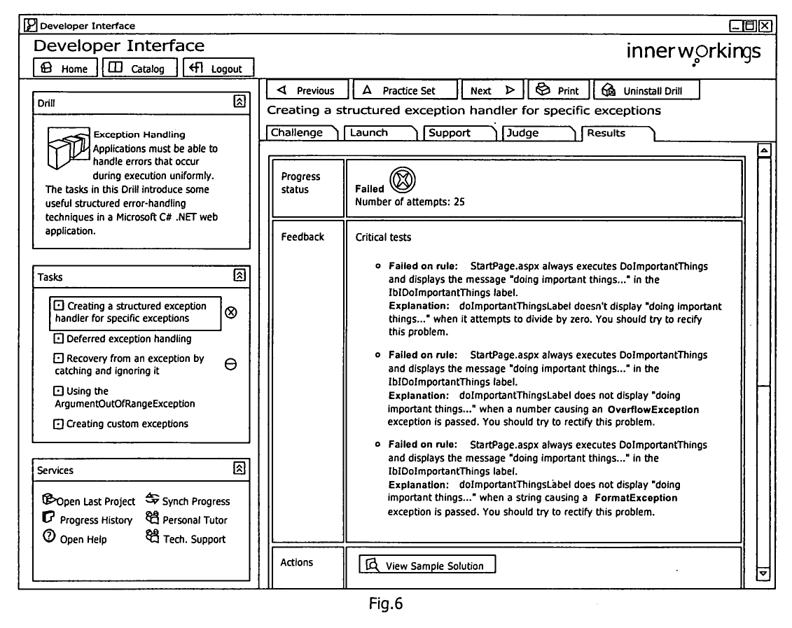

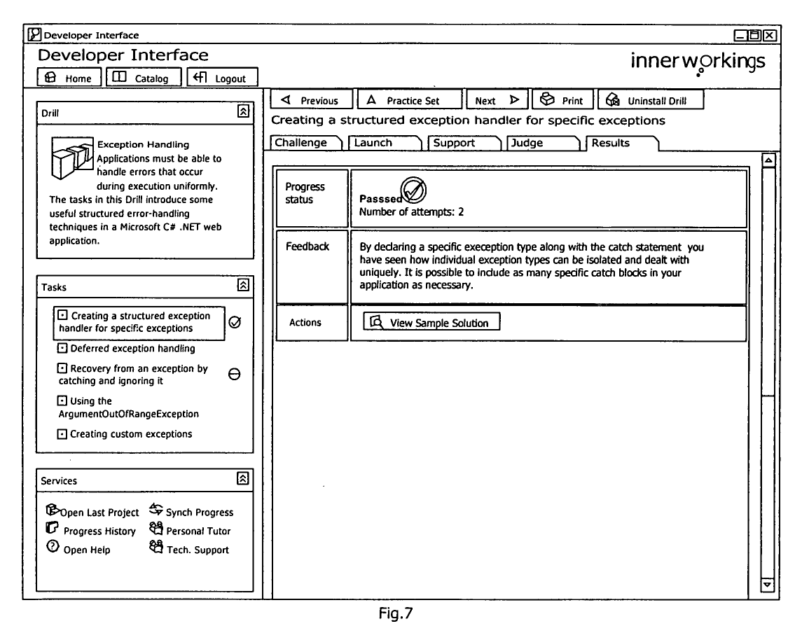

The code generated by the student is tested by the judging engine 8 when the student presses a “Judge” button in the Judge tab of the interface. The judging engine 8, in addition to automatically analysing the code, also monitors the number of attempts. If the student's attempt is unsuccessful, as shown in the sample screen of FIG. 6, the screen indicates that the code failed and provides a detailed breakdown of the reasons. Alternatively, if the student's attempt is successful, as in the sample screen of FIG. 7, the screen indicates that the code passed the testing phase and provides additional information on key learning points and best practices. The View Sample button is also enabled when the student passes the challenge. When pressed, it activates the engine 7 to present a sample code solution for comparison purposes.

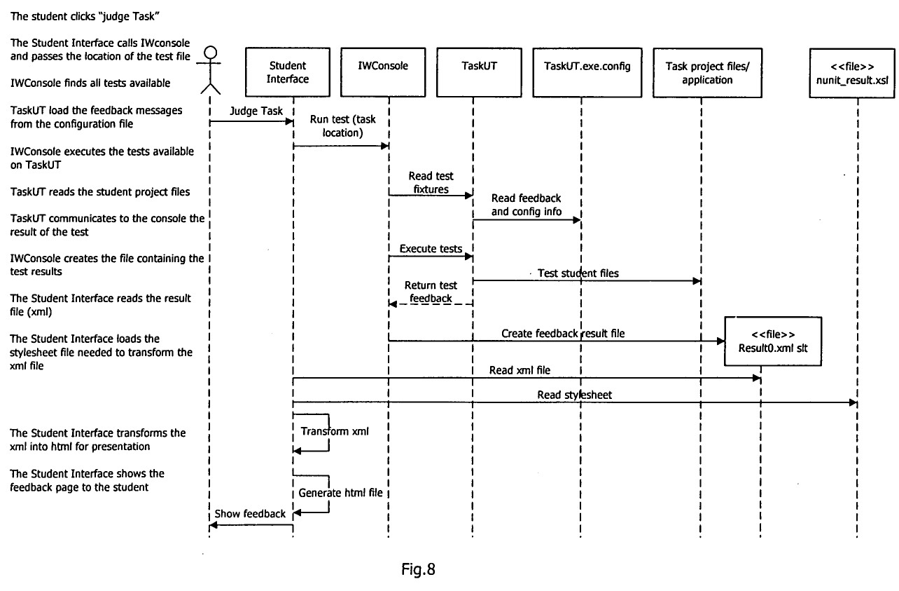

The overall operation is summarised for a typical scenario in FIG. 8.

Judging Engine: Overview

The judging engine 8 implements a testing practice called “unit testing”. A unit test is code that tests whether an individual module or unit of student code works properly. A software unit is commonly defined as the lowest level of code structure that can be separately compiled. In its simplest form, a unit may be a single function or method that has been isolated from the main body of application code. As such, unit testing is advantageous as it enables minute error testing of student code. This in turn provides the input for retrieving explanatory text for explaining why a failure has occurred.

Within this unit testing framework the judging engine 8 utilises:
(a) Black box and white box test design methods. Black box testing treats the system as a “black-box” and so does not explicitly use knowledge of the internal structure or programming code. Its primary objective is to assess whether the program does what it is supposed to do, as specified in the functional requirements. In contrast, white box testing requires the knowledge of a program's purpose and internals, and focuses on using this knowledge of the code to guide the selection of test data.
(b) Reflection. Reflection enables developers to obtain information about assemblies and the types defined within them, and to create, invoke and access type instances at runtime. It does this using the metadata information that is included with every assembly, which defines the type's methods, fields and properties.

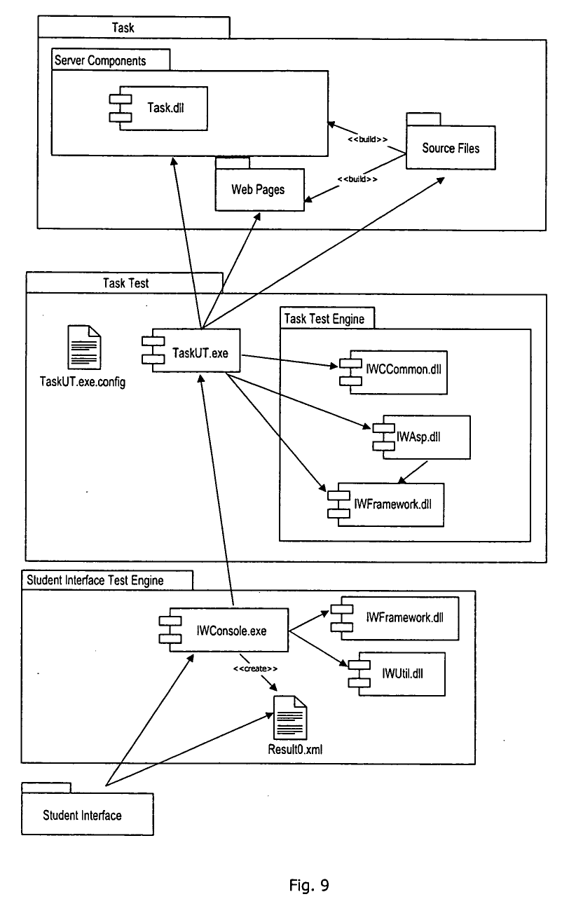

Referring to FIG. 9, the judging engine 8 comprises the following components.

| Filename | Purpose |
|---|---|
| TaskUT.exe | A TaskUT.exe executable is created for each task or |
| | application stage. It contains specific tests to perform |
| | black box and white box testing on the student's attempt |
| | at the challenge. TaskUT.exe uses the TaskUT.exe.config |
| | file to provide feedback to the student when a test fails. |
| | All TaskUT.exe tests are built and run using |
| | IW.framework.dll. The file also references IWAsp.dll and |
| | IWCommon.dll to avail of their additional functionality. |
| TaskUT.exe.config | This XML configuration file is task-specific and contains feedback |
| | for each individual test. The feedback is |
| | provided to the student on failure of a test to indicate why |
| | it failed. |
| IW.framework.dll | IW.framework.dll is a set of processes and code |
| | elements - a “framework” - that implements unit testing. |
| | It is used to build unit tests and runs the tests once |
| | completed. Attributes are used to denote a test routine to |
| | IW.framework.dll. Given an assembly, IW.framework.dll |
| | searches for these attributes, calls each test routine in |
| | turn, executes the code contained within it and reports |
| | on the tests. The console the engine 8 produces its results |
| | in XML format. |
| IWCommon.dll | This class library provides a basic infrastructure for task |
| | testing by supplying helper members to facilitate task test |
| | production. It defines classes that enable the parsing and |
| | testing of the task's source code. It also implements |
| | reflection to facilitate the testing of the student's |
| | assembly at runtime. |
| IWAsp.dll | IWAsp.dll is a class library that extends the functionality |
| | of IW.framework.dll by providing the ability to download, |
| | parse and manipulate ASP.NET Web Forms. IWAsp.dll |
| | provides several tester objects, which each represent one |
| | ASP.NET control on a web page. In this way, the page |
| | controls can be manipulated as required in tests. |
| IWConsole.exe | The version of IW.framework.dll. |
| IWWebControls.dll | A class library that runs alongside a student's code to |
| | facilitate server snapshots. This file resides with the |
| | student's task code rather than with the other testing files. |

When completed, the student creates a build of the project, which produces an assembly called Task.dll. So, to thoroughly assess the student's attempt at the task, the engine 8 tests:
the resulting HTML of the Web Form (StartPage.aspx)
the source code (StartPage.aspx.cs)
the runtime application (Task.dll)

To illustrate, let's examine a sample task. The task defines an ASP.NET application, which calculates the sum of a list of numbers in a file and returns the correct value. When the student types a filename into the text box and clicks a button, the calculation is performed and the result is displayed on screen. To pass the task, the student must address several requirements, three of which state that the application:
must not terminate abnormally when it attempts to read numbers greater than 100,
must not use On Error statements, and
must throw a GreaterThan100Exception exception if a line in the file stream contains a number greater than 100

On completion of a task, the student clicks the Judge button, which calls IWConsole.exe and passes the location of the test file (TaskUT.exe) to it. Once initialised, IWConsole locates the test attributes in TaskUT.exe, while TaskUT.exe loads the feedback messages contained in TaskUT.exe.config. IWConsole then runs all of the tests specified in TaskUT.exe, which test the student's code. When the tests are completed, TaskUT.exe provides IWConsole with the test feedback. IWConsole creates an XML file of these results and passes the file to the Developer Interface, where it is converted to HTML format and displayed to the student.

Judging Engine: Detailed Description

TaskUT.exe uses IWAsp's tester objects to perform black box testing on the produced HTML of the Web Form. By treating the elements of the page as tester objects, TaskUT.exe can provide a file name and perform the calculation. So for example, TaskUT.exe can provide the name of a file that contains numbers greater than 100. The expected result is that the application doesn't crash when it encounters the file—if it does, the test fails.

For white box testing, the engine 8 references an IWCommon class library to parse source code and locate code phrases that violate a task's requirements. In the sample below, the test fails if TaskUT.exe encounters an On Error statement in the MyMethod method of the MyClass class:

...
Dim CodeTester as VBCodeFile = new VBCodeTester(@“c:♯testfile.txt”))
Dim myClass as ICodeClass = VBCodeFile.GetClass(“MyClass”)
Dim myMethod as ICodeMethod = myClass.GetMethod(“MyMethod”);
Assertion.IsTrue(Task.GetFeedBack(“0001”), myMethod.Contains (“On
Error”) = 0);
...

As the internals of a student's assembly are undefined when TaskUT.exe is built, the judging engine 8 utilises reflection to enable the testing of the compiled assembly. In the sample task described above, the student's application must throw a GreaterThan100Exception exception if a line in the file stream contains a number greater than 100. However, as this exception type doesn't exist within the NET framework, the student must design and code the exception in its entirety. As a result, TaskUT.exe has no knowledge of its components, classes or methods, which it needs to perform accurate testing. To enable TaskUT.exe to extract this information, the IWCommon class library defines a class called Classtester.cs that implements reflection. Using this class, TaskUT.exe can interrogate the application to dynamically discover its runtime behaviour. In the sample below, TaskUT.exe tests whether the required exception class exists and contains the default constructor.

```
<TestMethod( )> _{—}
Public Sub CustomExceptionWorks( )
  Dim GreaterThan100ExceptionClass As ClassTester
  Try
    GreaterThan100ExceptionClass = New
      ClassTester(Task.NameSpace &
      “.GreaterThan100Exception”, Task.AssemblyPath)
  Catch ex As ClassNotFoundException
    Assertion.Fail(Task.GetFeedback(“0014”))
  Catch ex As ConstructorNotFoundException
    Assertion.Fail(Task.GetFeedback(“0024”))
  End Try
  Dim Message As String =
  GreaterThan100ExceptionClass.GetProperty(“Message”).ToString( );
  ...
```

In general, by analysing a student's source code, it is possible to discern a number of characteristics of the code that can lead to reasonable conclusions as to whether it correctly fulfils the requirements of the task. The student code can be routinely checked for, for example, the presence or absence of key words, and the order of keywords or phrases. It is possible to check the source code for any predictable characteristics by adding custom code to the engine 8. The student's code is processed to facilitate analysis. Comments are removed and the code files are decomposed into a number of their constituent parts.

All comments are stripped from the source code as the process of searching for the presence of keywords in the code could be confused by their presence in comment lines.

To make it easier to organise testing code that directly checks the student code, the student code is broken down by file into a source code tester class. The SourceCodeFile offers a view of a single source code file and can return objects representing the classes, methods, and properties defined in the file.

Classes created or modified by a student are represented by class objects (e.g. CSharpCodeClass) returned by the source code file object. The source code tester uses these method objects to test source code characteristics (e.g. the class declaration) or to retrieve methods and properties in the class. Methods and properties are represented by method and property objects. The methods in a class created or modified by a student are represented by method objects (e.g. CSharpCodeMethod). The source code tester uses these method objects to test source code characteristics (e.g. the presence or absence of keywords, or the order of a sequence of keywords). The properties in a class created or modified by a student are represented by properties objects (e.g. CSharpCodeProperty). The source code tester uses these properties objects to test source code characteristics (e.g. the presence or absence of properties, or the values of properties).

Used in conjunction with the process of dividing the code into sections, the engine 8 provides interfaces so that a degree of programming language independence can be achieved. Interfaces are provided for the student code file, class, methods and properties. For example, the source code file interface is defined as ICodeFile and is implemented in Visual C# by the CSharpCodeFile class and in Visual Basic NET by VBCodeFile. Code used to test a student's Task or Stage only needs to specify the language that the student code is expected to be in, and then subsequent calls to the source code testing methods are not dependent on the language. The following outlines the interface files.

ICodeFile

Interface that provides programming language independence when processing student code files.

ICodeClass

Interface that provides programming language independence when processing student code classes.

ICodeMethod

Interface that provides programming language independence when processing student code methods.

ICodeProperty

Interface that provides programming language independence when processing student code properties.

CShamCodeFile, CShanpClass. etc. (and VBCodeFile, VBClass)

Classes that provide implementations of the ICode interfaces in Visual C# and Visual Basic NET.

Basic HTML testing is implemented using code testers. The HTML produced by a Web application is regarded as the output of the student code. The HTML is converted to a standardised XML format and this information is parsed by code testers, so that it can be more easily examined as part of the code testing process. This functionality is fulfilled by NUnitASP.

One problematic aspect of testing Web applications is ascertaining the state of the Web server, which, because the testing engine is located on the Web client, is remote and not directly accessible. A certain amount of information about the state of the Web server can be inferred from the data inherent in the HTML of Web pages. This information is extracted and presented to the judging engine 8 in the form of code tester objects. For example, this HTML is generated by an Image control, which has an ImageUrI property. This is written as the “src” attribute in the HTML tag and this value is used for the ImageUrI property in the ImageTester.
<input type=“image”name=“_ctl2:infoButton”id=“_ctl2_infoButton”src=“exclamation.gif”alt=““border=“0”/>

The functionality described here is provided by NUnitASP.

Much of the information revealing the performance of a student's Web application code resides on the Web server and is ordinarily inaccessible to the client-based engine 8. For example, with an ASP.NET application, only the information needed to render a HTML page is sent to the client, while other information relating to the state of the Web server and the Web application itself remain on the server.

The process of revealing server-side state information begins with a snapshot of the state of a number of server state settings, not normally transferred to the client, being produced. Specifically, all of the controls associated with the page, whether visible or hidden, are examined and properties of these controls that are not normally available to client browsers are stored. Other information, for example items currently in cache, context, application, session and view state are also recorded. All of the information gathered during the rendering of the HTML page is organised into a hierarchy and written in an XML file. This functionality is facilitated by TestablePage, described in more detail below.

The XML is encoded and written as part of the page HTML output in a hidden div element. The engine 8 identifies itself to the ASP.NET application, and it is only when the client is recognised as the engine 8 that the extra information is made available and added to the HTML page. This means that a normal use of the ASP.NET application, accessing it through a standard web browser will see no evidence of this testing engine feature. The HTML page bearing the extra server-side information may take longer to download, so making it available only to the engine 8 means that the performance of the application when accessed though a standard web browser is unaffected.

The XML is retrieved by testers in the judging engine 8. The testers can then act as proxies for the controls that are not normally visible on the client. The engine 8 can access the testers as if they were the controls themselves, and thus the full set of server-side control properties are revealed.

Active aspects of student code can be tested by actively exercising controls and examining the results. This, again, is akin to data input and output testing; the input being the stimulation of a control, for example a button click or a list selection, and the output being the changes affected by the action. The basic premise here is the simulation of student activity toward a software application. For example, a button tester has a click method which simulates a student actually clicking on the button. The ButtonTester click method causes a postback which in turn causes the server state and HTML page to be updated. The testing engine would typically test the state of another element of the HTML page which would have been expected to change as a result of the button click.

Reflection is used in the judging engine 8 to examine compiled code and can provide either a cross check for code characteristics revealed by source code checking, or an alternative view of the structure of the code. In addition to examining the application statically, reflection can be used to instantiate classes and run individual methods within a class. This provides a means of ‘dissecting’ a software application and testing specific aspects of the code that is related to the code the student has changed.

When a challenge requires a developer to introduce new code, it is possible to check the code produced from the binaries using reflection. The following are the structural elements that can be examined: assemblies, classes, methods, properties, fields, and attributes.

An example of the kind of question that can be asked using reflection is: “Does SomeControl contain a Text property?”, or “Does it contain a method SomeMethod that takes a string as a parameter?”.

In addition to embedding reflection into the engine 8, the use of testers allows the engine 8 to take advantage of late-binding. This is where a method to be called is defined as a string at runtime, rather than at compilation time. Late binding is an important aspect of the engine 8. This is because the engine 8 frequently seeks to execute the student code. Because the student code, and possibly the entire method that contains it, does not exist when the tests are published, early binding would cause compilation errors in our tests. The following are examples of early and late binding.

Early binding
============
// Compiler checks SomeMethod exists, plus you need
// to reference the DLL containing MyClass when you compile
// your program
MyClass c = new MyClass( );
c.SomeMethod( );
c.SomePrivateMethod( ); // won't compile
Late binding
============
// Don't need to have access to MyClass.dll when we compile
// No compile-time checks
Type myClassType = GetMyClassType(“assembly.dll”, “MyClass”);
object c = Activator.CreateInstance(myClassType);
MethodInfo m = myClassType.GetMethod(“SomeMethod”);
m.Invoke(c);
MethodInfo m = myClassType.GetMethod(“SomeMethod”,
BindingFlags.NonPublic);
m.Invoke(c);

Finally, using testers and late binding also allows the engine 8 to access private members of classes. This is advantageous in testing student code. It is illustrated in the late binding example above in the line:
MethodInform=myClassType.GetMethod(“SomeMethod”, BindingFlags.NonPublic);

Server-side testing employs code that executes alongside the student code. As the code runs on the server, it can interrogate it at much closer quarters, and can determine characteristics and behaviour otherwise hidden to the testing engine. Server-side testing runs simultaneously with the student code, so information can be gathered at numerous times during execution. Once triggered, server-side tests can actively manipulate objects in the student code, thus greatly increasing the quality and type of test to be run. Server-side tests can examine the action of any event handler that executes prior to the moment of rendering the HTML page destined for the client, and indeed any other student code that is executed. Any information that is available to objects in the student code can be gathered for testing by the server-side tests. For example, server-side tests can access complex protected or private properties of server controls (e.g. ViewState) which would not be serialized as part of the snapshot process.

The server-side testing system includes components active on both the client and server side, and like other testers in the judging engine 8, it breaks down into a tester (ServerTester) and TestablePage functionality.

ServerTester

The ServerTester object essentially triggers server-side execution of the student code by, on the client, requesting a particular page from the server. The ServerTester object is instantiated with a reference to the current web form, and so testing code may call it freely. The ServerTester provides a means for attaching an ASPServerSuite derived object to a page request and later collecting any assertions caught during execution of server tests. ASPServerSuite offers a set of virtual methods related to the server event cycle. The real events on the server, for example Init, Load, DataBinding, PreRender are ‘hooked’ so that when they occur, not only are their normal event handlers evoked, but so too are the matching methods in the ASPServerSuite-derived object. A test to be written for a task can use the virtual event methods of ASPServerSuite to apply code that reports on actions and states that occur during the handling of events.

TestablePage

As for server-side snapshot testing, TestablePage provides a framework that serialises data relating to the server state, encodes it, and includes it in the HTML output that transports it to the engine 8 on the client. For server-side testing, TestablePage performs the additional function of loading a test suite (encapsulated in classes derived from a class called ASPServerSuite). In line with the exception-based testing, the test suite may generate exceptions, indicating code that violates the testing conditions. TestablePage catches any exceptions that are thrown as a result of test suite actions, and performs the “serialisation”, in this case serialising information relating to the exception caught, and encodes the serialisation (with the HTML output) as described above.

The TestablePage is injected into compiled student code by decompiling the task application (including the student's code) to an intermediate language format, identifying any references to the Web page base class (i.e. system.Web.UI.Page) from which all Web pages are derived, and changing these reference to our class TestablePage. TestablePage in turn refers to the Web page base class. The code is then recompiled

Once inserted into the task application, TestablePage acts as a “hub” to call monitoring and testing code which exists on the server. Thus, the overall testing code on the server includes both the injected TestablePage and test functions statically present on the server

A typical request looks like the following:
GET /ServerTesterDemo/WebApp/StartPage.aspx HTTP/1.1
Student-Agent: IWAsp
IW-ServerTest:
C%3a%2flnetpub%2fwwwroot%2fServerTesterDemo%2fTester%2fbin%2fDebug%2fTester.exe%7clnnerWorkings.Test.Critical%2bGetCityTestSuite
Connection: Keep-Alive
Host: localhost

The header added by ServerTester is as follows:
IW-ServerTest:
C%3a%2flnetpub%2fwwwroot%2fServerTesterDemo%2fTester%2fbin%2fDebug%2fFester.exe%7clnnerWorkings.Test.Critical%2bGetCityTestSuite

It is URL encoded, and the value defined after IW-ServerTest: looks like the following when unencoded:
C:\Inetpub\wwwroot\ServerTesterDemo\Tester\bin\Debug\Tester.exe|InnerWorkings.Test.Critical+GetCityTestSuite

The class name InnerWorkings.Test.Critical+GetCityTestSuite indicates that GetCityTestSuite is a nested class inside the lnnerWorkings.Test.Critical class. Both are contained within the file Tester.exe indicated in the first part of the value.

A GetPage request is then issued to ASP.NET, identifying the page that it is required to test. The page that is requested will be inherited from the TestablePage class, which itself is derived from system.web.Ul.page. That means that TestablePage, like system.web.UI.page, is the parent of all pages in the web application and therefore the child pages inherit behaviour.

When ASP.NET receives the page request, TestablePage checks the HTTP header for a reference to the tester class. The tester class is written specifically for the test that is to be carried out, i.e. (it is unique to the task or stage that the test is part of). In the example above, the tester class is GetCityTestSuite, contained in the class InnerWorkings.Test.Critical, which is contained in the file Tester.exe. ASP.NET uses reflection to instantiate just the class associated with the required test, GetCityTestSuite in this case.

At this point, TestablePage also “hooks” a number of events that are essential to the process of creating a new web page. Hooking events means that when the event is raised, code supplied by TestablePage gets a chance to respond to it instead of the default classes supplied by ASP.NET. This allows access by the engine 8 to the actual process that creates the Web pages that are ultimately sent to the web browser.

When TestablePage receives the events, it first calls the ASP.NET event handlers that would have been called in the normal course of events, thus making its own presence transparent. When the ASP.NET event handlers have returned, TestablePage then runs the tests that are required to judge a student code. The following code from TestablePage illustrates this for the OnInit event:

```
protected override void OnInit(EventArgs e)
{
  base.OnInit(e);
  LoadServerTestSuites( );
  RunServerTests(OnInitEventHandlers, e);
}
```

There are a number of events that are raised during the course of creating an ASP.NET Web page. These include:
The page's constructor is called
Its controls are instantiated
Its Init event is called
Its ViewState event is called
Its Load event is called
Any specific event handlers related to the reason the page is being created are called
Its DataBinding event is called
Its PreRender event is called

And at this point the page is rendered.

TestablePage can intercede at any of the points from Init onwards, and by running test code before and after an event, for example, can determine what happened during that event. In conjunction with the ASP.NET system code, the student's code is responsible for what happens during the event, so in that way the engine 8 can determine if their solution is what was required of the task or stage.

Any tests that fail are expressed as assertions which throw exceptions, and these are caught by TestablePage. TestablePage then serialises the information relating to the failed tests into the HTML of the rendered page, and this is then transferred to the client. When the HTML page is received on the client, the serialised exception information is retrieved, and the assertions raised originally on the server are rethrown on the client. These are caught by the judging engine as any other testing failure would be.

In most cases, the test code to test a student's code within a task can be reduced down to a simple assertion call. The process involves the following steps:
1. Get the Tester proxy representing the item under test
2. Use the Tester's properties and methods to identify the specific characteristic of the item under test that is to be examined
3. Call Assert.IsTrue to determine that the characteristic is what it is expected to be.
4. IsTrue does nothing if results are expected
5. IsTrue throws an exception of the results are anything unexpected
6. The exception is caught by the testing engine.
7. The exception is reported to the student. In most cases, the exception message is replaced by our own exception message that comes from the file TaskUT.exe.config that accompanies every Task and Stage.

The following code shows an example of the use of assertion-based testing.

[Test]
public void TestResultLabelIsUpdated( )
{
// when myButton is clicked, the Text property of resultLabel should be
// set to “The text”
ButtonTester myButton = new ButtonTester(“myButton”,
CurrentWebForm);
LabelTester resultLabel = new LabelTester(“resultLabel”,
CurrentWebForm);
myButton.Click( );
Assert.IsTrue(Task.GetFeedBack(“0002”), resultLabel.Text ==
“The text”);
}

Testers are used as an interface between the testing code written to judge a task or stage and the application that the student has modified and which is the subject of the task or stage. In providing this interface, Testers are required to perform a number of functions. Primarily, they act as proxies to application elements that are not available directly to the engine 8. They also act as proxies to application elements that are more useful to the engine 8 if they are abstracted from their normal form to one more in line with the testing requirements. For example, source code testing and reflection testing techniques are abstracted and made more reusable and maintainable. Through the use of interface based programming, they also help to offer a degree of source code language independence.

The first role of a Tester is to provide a proxy for an object under test. For example, ButtonTester represents an ASP button on a page. Both the button object and the ButtonTester object have a property ‘Text’, and both will have the same value. The ButtonTester object will always be accessible to the testing engine, while often the original button object will not. Creating a ButtonTester is simply a matter of instantiating a new object and giving it a reference to a Web page, for example,
ButtonTester proxyButton=new ButtonTester(“submitButton”,<reference to Web form>);

The constructor for the proxyButton object will obtain the information from the encoded data passed from the web server.

ICodeClass represents a class in a code file. The testing code can create a proxy Tester for this class and can query the Tester about methods and properties that the class contains. For example, the test for a Task or Stage might declare an ICodeClass object:
CSharpCodeTester sourceFile=new CSharpCodeTester(“myclass.cs”);

ICodeClass myclass=sourceFile.GetClass(“MyClass”);

It is then possible to obtain methods and properties from this class (including private methods and properties) using the GetMethod and GetProperty methods. The methods or property is returned as an ICodeMethod or ICodeProperty object, respectively. For example, the test might seek the value of a property thus:

ICodeProperty myClassProperty = myClass.GetProperty(<property
name>);
ICodeFragment getter = myClassProperty.GetGetMethod( );
if (getter.Contains(“IsPostBack”) > −1)
// test succeeds

Multiple implementations of these interfaces are defined so that different code languages (e.g. Visual C#, Visual Basic .NET) can be targeted by simply instantiating a different tester (e.g. CSharpCodeTester vs. VBCodeTester).

Another type of Tester, ClassTester, provides an abstraction for the reflection API that is used in many testing engine tests. ClassTester makes available methods and properties that reveal the behaviour and state of an object under test.

public class MyClass { private int MyMethod(string s) { return s.Length }
}
ClassTester myClassTester = new ClassTester(typeof(MyClass));
Assert.IsTrue(myClassTester.CallMethod(“MyMethod”, “abc”) == 3);

There are a number of Tester types established, but Tester can be added at any time. These include:
ASP Testers:
   ButtonTester, DropDownListTester, CalendarTester, etc.
HTML Tester:
   DivTester, TableTester, ImageTester, AnchorTester
Reflection Tester:
   ClassTester
ASP Server State Testers:
   CacheTester
   ViewStateTester

Testers allow the engine 8 to gain access to some aspects of Web applications that are normally not visible to a client application. They can do this because of an adaptation we have made to the normal hierarchy of classes that define .NET applications. We will take an example of an ASP.NET Web application.

Every ASP.NET page is an instance of an interface called IHttpHandler, which defines a single method enabling a class to process an HTTP request. Specifically, most pages derive from the base class System.Web.UI.Page which implements the IHttpHandler interface and provides other services to the ASPX page including ViewState, the postback mechanism and a series of events that occur at different stages during the processing of an HTTP request.

Pages to be tested derive instead from a class in the testing framework called TestablePage which is itself derived from System.Web.UI.Page. This class adds two extra functions: the capturing of the state of server side objects (including the entire control hierarchy and the contents of the Session, Cache, Context and Application collections), and the running of server-side tests.

Server side state is captured when the page is rendered to HTML. At this stage an extra div element is added to the output which contains an encoded XML document. The XML document details the control hierarchy and selected properties of each control. This information is used by the Testers to access information that would not normally be serialized in HTML.

TestablePage itself refers to the System.Web.UI.Page, so the integrity of the application is maintained, but the pages in the application now have the behaviour of TestablePage added. This means that then the application is executed by the testing engine, the hidden information from the server needed by the Testers is made available. However, the source code contains no vestige of this mechanism.

It will be appreciated that the invention provides for dynamic education of a student with presentation of “live environment” tasks, support services to assist with performance of the tasks, and automatic judging and feedback. This completes automatically a full training cycle, giving effective live environment training to the student. It is also very advantageous to have a detailed breakdown of any mistakes, providing a profile which is of benefit to the student.

The invention is not limited to the embodiments described but may be varied in construction and detail. For example, in the embodiments described the development tool is Visual Studio.NET. However they could be of any desired type.

1. A computer-based learning system comprising a learning controller for presenting learning content to a student, and
a launch function for launching a computer application providing a live programming environment,
a task function for presenting a task to a student involving use of an application, and
a judging engine for testing student success when performing the task in the live programming environment.

2. A learning system as claimed in claim 1, wherein the application is a software development tool, and the judging engine tests software code developed by the student.

3. A learning system as claimed in claim 2 wherein the task function generates a task comprising student instructions for writing software code, and starting software code to be edited or expanded by the student.

4. A learning system as claimed in claim 3, wherein the task function resets student code upon receipt of a student instruction to initiate a fresh task.

5. A learning system as claimed in claim 1, wherein the judging engine maintains a count of the number of attempts at completion of a task by a student in a session.

6. A learning system as claimed in claim 1, wherein the judging engine automatically generates a detailed explanation of where student mistakes were made.

7. A learning system as claimed in claim 1, further comprising a support engine for retrieving support content in response to a student request.

8. A learning system as claimed in claim 7, wherein said support engine accesses remote servers to retrieve support content.

9. A learning system as claimed in claim 2, wherein the judging engine comprises configuration files of potential student feedback messages, and automatically selects messages in response to testing.

10. A learning system as claimed in claim 9, wherein the configuration file is in mark-up language format, and selected messages are rendered to HTML for display at a student interface.

11. A learning system as claimed in claim 2, wherein the judging engine comprises black box testing functions for executing student code and determining success or failure according to overall code performance.

12. A learning system as claimed in claim 2, wherein the judging engine comprises functions for parsing student code to analyse it.

13. A learning system as claimed in claim 12, wherein comments are automatically stripped from the code.

14. A learning system as claimed in claim 12, wherein the code is parsed to detect key words.

15. A learning system as claimed in claim 12, wherein the student code is automatically broken down into its constituent parts, including classes, methods, and properties.

16. A learning system as claimed in claim 15, wherein the judging engine individually tests constituent parts.

17. A learning system as claimed in claim 16, wherein the judging engine includes interface files which provide student programming language independence when testing the student code constituent parts.

18. A learning system as claimed in claim 2, wherein the judging engine comprises reflection functions for examining student structural elements including assemblies, classes, methods, properties, fields, and attributes.

19. A learning system as claimed in claim 18, wherein the judging engine performs reflection testing of methods for late binding, in which the method is defined as a string at runtime.

20. A learning system as claimed in claim 2, wherein the judging engine activates monitoring code to execute alongside student code and monitor performance of the student code.

21. A learning system as claimed in claim 20, wherein the monitoring code captures exceptions generated by the student code.

22. A learning system as claimed in claim 21, wherein the monitoring code generates a mark-up language representation of the exceptions, and the judging engine interprets the mark-up language representation.

23. A learning system as claimed in claim 20, wherein the monitoring code is automatically inserted by the judging engine into compiled student code so that it is non-invasive and transparent to the student.

24. A learning system as claimed in claim 23, wherein the judging engine decompiles original binary-level student code to an intermediate-level language, inserts the monitoring code into the intermediate-level language, and re-compiles to provide fresh student binary-level code.

25. A learning system as claimed in claim 24, wherein the monitoring code comprises a testable page which calls monitoring functions.

26. A learning system as claimed in claim 25, wherein the testable page is inserted in the intermediate language by changing references to a prior page to the testable page, and in which the testable page refers to the prior page so that operation of the student code is unaffected.

27. A learning system as claimed in claim 22, wherein the monitoring code inserts the mark-up language representation of the exceptions into a page downloaded from a server to a client, thereby enabling the client side to view operations of the server side which would otherwise be hidden.

28. A learning system as claimed in claim 27, wherein the judging engine comprises a tester object for activating a test of server-side student code by, from the client side, requesting a page from the server side.

29. A method of operation of a computer-based learning system comprising the steps of;
generating a live programming environment with launch of a software development tool;
presenting instructions of a programming task to a student, the task to be completed using the development tool;
providing access to automated support services for guidance of a student undertaking the programming task;
automatically testing program code developed by the student; and
presenting test results to the student with an analysis of any mistakes made.

30. A method as claimed in claim 29, wherein the student code is automatically tested with white box analysis of the student code by monitoring code, the monitoring code capturing exceptions generated by the student code while executing.

31. A method as claimed in claim 30, wherein the exceptions are converted to a serialisation information stream in a mark-up language.

32. A method as claimed in claim 31, wherein the information stream is incorporated with HTML transmitted by a server to a client.

33. A computer program product comprising software code for performing steps of a method of claim 29 when executing on a digital computer.
